(19) United States
(12) Patent Application Publication
(10) Pub. No.: US 2021/0331523 A1
(43) Pub. Date: Oct. 28, 2021

(54) TIRE COMPRISING A TREAD WITH REINFORCING ELEMENTS

(71) Applicant: COMPAGNIE GENERALE DES ETABLISSEMENTS MICHELIN, Clermont-Ferrand (FR)

(72) Inventors: FRÉDÉRIC PERRIN, Clermont-Ferrand (FR); SYLVAIN MORIVAL, Clermont-Ferrand (FR); RÉMI REYNAL DE ST-MICHEL, Clermont-Ferrand (FR)

(21) Appl. No.: 16/485,998

(22) PCT Filed: Feb. 14, 2018
(86) PCT No.: PCT/FR2018/050353

§ 371 Date: Aug. 14, 2019

(30) Foreign Application Priority Data
Feb. 14, 2017 (FR) 1751181

(51) Int. Cl. B60C 11/00

(52) U.S. Cl. CPC B60C 11/0058; B60C 2011/0025; B60C 11/0008

(57) ABSTRACT

A tire having a tread comprising at least one circumferential reinforcing element 8 of which at least part of the meridional cross section has the shape of a triangle, the vertex of which is oriented radially towards the outside, the circumferential reinforcing element 8 comprising a skin 81 and a core 82, the skin material being at least twice as stiff as the core material.

### FIELD OF THE INVENTION

The present invention relates to tyres, and more particularly to a tyre the grip performance of which is improved.

In general, a tyre is an object with a geometry exhibiting symmetry of revolution about an axis of rotation. A tyre comprises two beads intended to be mounted on a rim; it also comprises two sidewalls connected to the beads, a crown comprising a tread intended to come into contact with the ground, the crown having a first side connected to the radially outer end of one of the two sidewalls and having a second side connected to the radially outer end of the other of the two sidewalls.

The makeup of the tyre is usually described by a representation of its constituent components in a meridian plane, that is to say a plane containing the axis of rotation of the tyre. The radial, axial and circumferential directions denote the directions perpendicular to the axis of rotation of the tyre, parallel to the axis of rotation of the tyre and perpendicular to any meridian plane, respectively. In the following text, the expressions “radially”, “axially” and “circumferentially” mean “in a radial direction”, “in the axial direction” and “in a circumferential direction” of the tyre, respectively. The expressions “radially on the inside or, respectively, radially on the outside” mean “closer to or, respectively, further away from the axis of rotation of the tyre, in a radial direction”. The equatorial plane is a plane perpendicular to the axis of revolution of the tyre, positioned axially in such a way as to intersect the surface of the tread substantially mid-way between the beads. The expressions “axially on the inside or, respectively, axially on the outside” mean “closer to or, respectively, further away from the equatorial plane of the tyre, in the axial direction”.

### PRIOR ART

As is known, the tread of a tyre is provided with a tread pattern comprising, notably, tread pattern blocks delimited by various main, longitudinal or circumferential, axial or else oblique grooves, the elementary blocks also being able to have various finer slits or sipes. The grooves form channels for draining off water when running on wet ground; the walls of these grooves also define the edges of the tread pattern blocks.

In order to improve the grip of a tyre it is advantageous to use tread compounds of low stiffness, so as to improve the level of contact between the rubber compound and the roadway. This type of design is very conventionally applied to competition tyres, which have low tread-pattern heights and a very small wearable volume of rubber compound. However, for passenger vehicle tyres, the height of the tread pattern needs to be sufficient to ensure satisfactory distance endurance on the one hand and the tread pattern needs to comprise sufficient grooves to remove water if running on wet ground. It has always proven to be difficult to use low-stiffness rubber compounds for passenger vehicle tyres. This is because the presence of a tread pattern, which means to say grooves of a design sufficient to allow running on wet ground under good safety conditions, renders the tread very flexible, and this impairs the roadholding of the vehicle under cornering because the tyre does not develop sufficient thrust in the axial direction during turns.

In order to provide an improvement to overall performance in the event of using rubber tread compounds of low stiffness, document WO2016/174100 proposes using a rubber tread compound of low hardness and reinforcing the tread by including therein one or more circumferential reinforcements having a triangular shape, viewed in meridional section, said triangle having its vertex oriented radially outwards.

In another context, document EP2708382 also proposes another shape of reinforcement made from a rubber compound different from the compound of the main part of the tread; this time, the reinforcement is positioned in the bottom of the grooves of the tread pattern and on either side of the said grooves; the parts positioned on either side of the grooves also have the appearance of a triangle, the vertex of which is oriented radially outwards.

Unfortunately, the increase in stiffness thus obtained impairs the rolling resistance, which is a performance aspect of key importance.

### BRIEF DESCRIPTION OF THE INVENTION

The subject of the invention is a tyre comprising a crown reinforcement and a tread radially on the outside of the crown reinforcement, the tread having a contact face intended to come into contact with the roadway when the tyre is running, the said tread comprising at least one circumferential reinforcing element of which at least part of the meridional cross section has the shape of a triangle the vertex of which is oriented radially towards the outside, characterized in that the circumferential reinforcing element comprises a skin and a core, the skin being at least twice as stiff as the core.

Thus, because only the skin of the reinforcing element is very stiff, the effect whereby the rolling resistance is increased as a result of the addition of a reinforcing element into the tread is markedly limited. The core of the reinforcing element could even be empty of any material, something which manifestly complies with the requirement for the skin to be at least twice as stiff as the core. However, even if only for the sake of ease of manufacture, a material will usually also be used for the core. Materials that are well suited to the production of tyres are rubber compounds. Thanks to the use of a stiff skin compound according to the teachings of the aforementioned document WO2016/174100, the desired reinforcing effect is sufficiently maintained.

A person skilled in the art will therefore have a broader scope to adjust the stiffnesses in order to obtain a better compromise between the grip of the tyre and the axial thrust it is capable of developing. Advantageously, with the skin and the core being made from a rubber compound, if the dynamic shear modulus G* measured at 60° C. at 10 Hz under alternating shear stress of 0.7 MPa is considered to be the descriptor indicative of the stiffness of the rubber compound, the dynamic shear modulus G* of the skin compound is preferably at least twice as high as the dynamic shear modulus G* of the core compound. Most of the time, the tread is made from a rubber compound; for preference, the dynamic shear modulus G* of the skin compound is at least twice as high as the dynamic shear modulus G* of the rubber compound or compounds of the compound of the rest of the tread. Because the core part is not functional in terms of the stiffness, its composition can be adjusted so that it exhibits little stiffness and little hysteresis, this being to the benefit of low rolling resistance. Because stiffness and hysteresis are connected, that allows a lower-hysteresis core material to be selected. It is the skin part that is functional in terms of the stiffness. Its composition can be adjusted so that it is very stiff; but because its overall volume is small, its (unfavourable) contribution to the rolling resistance remains small; because its orientation is inclined as a result of the triangle shape, its (favourable) contribution to the development of axial thrust, referred to as drift thrust, is extremely high because the material is working in its ideal way.

While the overall appearance of the reinforcing element is the shape of a triangle when viewed in meridional cross section, it must be appreciated that there are a plurality of geometries (when viewed in meridional cross section) that meet the requirements of the present invention. The essential feature is for the width of the reinforcing element, measured axially, to reduce progressively through the reinforcing element radially from the inside towards the outside, without too abrupt a variation. The remainder of the description will provide the person skilled in the art with a number of examples of suitable shapes for the reinforcing element. The shape of the circumferential reinforcing element has a cross section that tapers radially towards the outside. That improves its effectiveness. The walls of this circumferential reinforcing element may be concave, convex or in the form of a staircase. For preference, the angle formed by the two lateral walls of the circumferential reinforcing element(s) is greater than 35 degrees. Below 35 degrees, observations made by the applicant demonstrate that the effectiveness is reduced.

For preference, the mixture of rubbers of which the skin rubber compound is made has a dynamic shear modulus G* (measured at 60° C. at 10 Hz and under an alternating shear stress of 0.7 MPa) of greater than 5 MPa and preferably greater than 10 MPa. Highly advantageously, the tread rubber compound has a dynamic shear modulus G* less than or equal to 1.3 MPa and preferably less than 1.1 MPa. The presence of the circumferential reinforcement makes it possible to make full use of the grip capabilities of such a very low stiffness tread compound. This is particularly useful in the case of a tyre for a passenger vehicle.

Another advantage of the invention lies in the observation that it allows the production of tyres which are such that the balance of the vehicle is far less sensitive to differential wearing between the tyres fitted at the front of the vehicle and the tyres fitted at the rear of the vehicle. This is because the core rubber compound is a material that has low stiffness. It is well known to those skilled in the art that the stiffness of the tread increases with tyre wear. When use is made of a tread material of low stiffness, the addition of the reinforcing element is necessary for obtaining sufficient stiffness when the tyre is new; however, once the tyre becomes part worn, this reinforcing element is no longer necessary. When the tyre is part worn, the skin of the reinforcing element no longer provides continuity at the vertex in contact with the ground. The core material then comes into contact with the road. In such an instance, there is practically no longer any effect whereby overall stiffness increases with wear, or the effect is no more pronounced than in a tread that is not reinforced with triangular reinforcing elements.

The circumferential reinforcing element may be laid directly on the crown reinforcement of the tyre or laid on a sublayer or on a thickness of 1 mm to 2 mm of the material of which the tread is chiefly made.

According to another advantageous embodiment, the tread comprises two different compounds arranged axially one on top of the other. The compound arranged radially on the inside is usually referred to as a “sublayer”. This sublayer may have more favourable hysteresis properties than the compound in contact with the road surface, thus improving the overall rolling resistance property of the tyre. Alternatively, the sublayer may also be stiffer than the rubber compound of the tread in order to stiffen same. The reinforcing element may then rest on the external surface of this sublayer, while maintaining the advantage, in terms of tyre operation, of bearing directly or almost directly on the crown reinforcement of the tyre.

The invention relates more particularly to tyres intended to equip vehicles having four or more wheels (passenger vehicle, notably of sports type), of the passenger vehicle type, of SUV (“Sports Utility Vehicle”) type, or else to equip two-wheeled vehicles (especially motorcycles) or else aircraft, industrial vehicles (vans, heavy-duty vehicles, that is to say, underground trains, buses, heavy road transport vehicles such as lorries, tractors and trailers therefor, or off-road vehicles, such as heavy agricultural or construction plant vehicles, or else handling vehicles). The invention may equally well be applied to inflated assemblies referred to as “pneumatic tyres” or to non-pneumatic tyre assemblies.

### DESCRIPTION OF THE FIGURES

The objects of the invention will now be described with the aid of the appended drawing, in which:

FIG. 1 depicts, highly schematically (without being true to a specific scale), a meridional section through a tyre in accordance with one embodiment of the invention;

FIG. 1b depicts, highly schematically (without being true to a specific scale), a meridional section through a tyre comprising a sublayer in accordance with one embodiment of the invention;

FIGS. 2a to 2e, 3a to 3d, 4a and 4b depict, in meridional section, variations in the shape of an element of the invention;

FIG. 5 highly schematically depicts an alternative form of embodiment of the invention;

the drawings that make up FIG. 6 highly schematically depict alternative forms of embodiment of the invention when 2 reinforcing elements are positioned either side of a longitudinal groove.

### DETAILED DESCRIPTION OF THE INVENTION

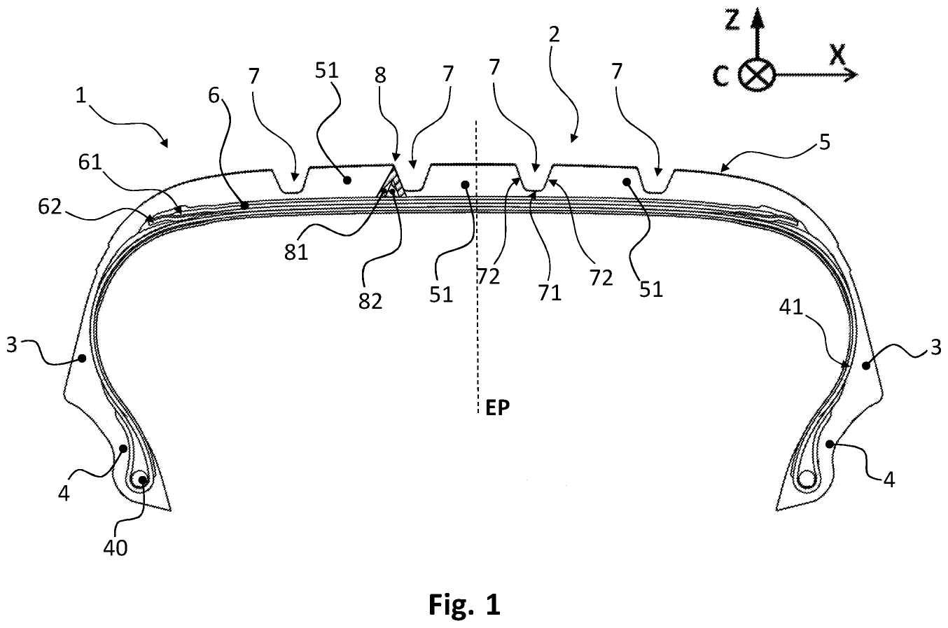

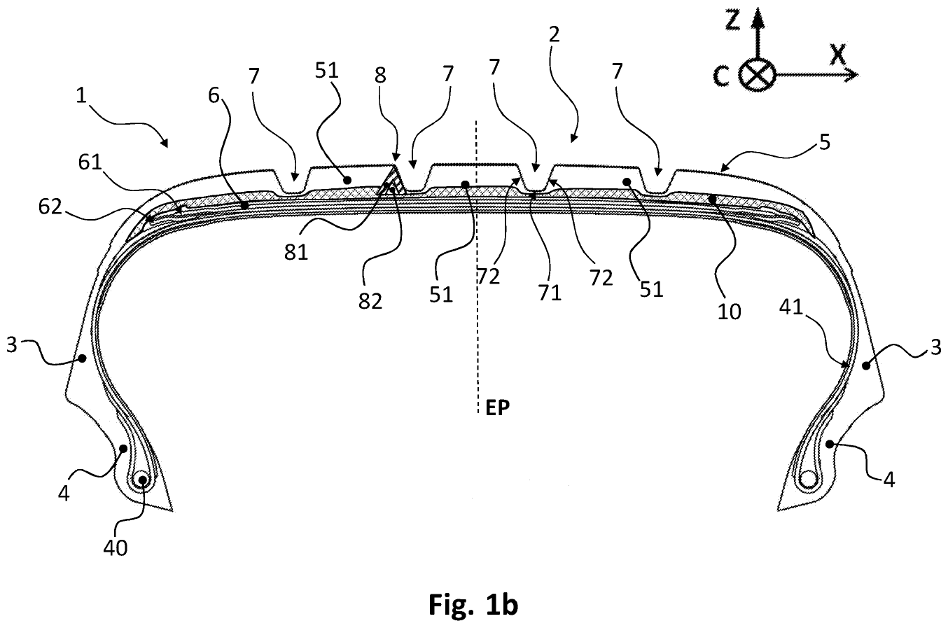

FIG. 1 shows a tyre 1 comprising a crown 2, two sidewalls 3 each connected to a bead 4. The crown 2 is connected on each side to the radially exterior end of each of the two sidewalls. The crown 2 comprises a tread 5. FIG. 1 shows an equatorial plane EP, which plane is perpendicular to the axis of rotation of the tyre, situated mid-way between the two beads 4 (mounted on rim) and passing through the middle of the belt reinforcement; FIG. 1 also indicates, by arrows placed just above the tread 5, on the equatorial plane EP, the axial X, circumferential C and radial Z directions.

Each bead has a bead wire 40. A carcass ply 41 is wrapped around each bead wire 40. The carcass ply 41 is radial and is, in a manner known per se, made up of cords; in this implementation, textile cords; these cords are arranged substantially parallel to one another and extending from one bead to the other in such a way that they form an angle of between 80° and 90° with the equatorial plane EP.

The tread 5 comprises a plurality of tread pattern blocks 51. Two tread pattern blocks are axially separated by a groove 7, each of the said grooves 7 extending at least partially circumferentially, each circumferential groove 7 being axially delimited by two lateral faces 72 and delimited radially towards the inside by a groove bottom 71. At least some of the said tread pattern blocks 51 comprise at least one circumferential reinforcing element. In FIG. 1, there is just one circumferential reinforcing element 8 in just one tread pattern block 51.

The crown 2 comprises a crown reinforcement 6 comprising two belt plies 61, 62; the carcass ply 41 is also present in the crown. In a very conventional way, the belt plies 61, 62 are formed of metal cords arranged parallel to one another. In a way that is well known, the reinforcing elements that the cords of the carcass ply 41 and the cords of the belt plies 61, 62 form are oriented in at least three different directions so as to form a triangulation.

The crown reinforcement 6 could also comprise a hooping ply made up of hoop reinforcers formed of organic or aromatic polyamide fibres forming, with the circumferential direction, an angle at most equal to 5°. The crown reinforcement 6 could also comprise other reinforcers, oriented at an angle closer to 90°; the makeup of the crown reinforcement does not form part of the invention and, in this document, when reference is made to the radially exterior surface of the belt reinforcement, that means the radially outermost level of the radially outermost layer of reinforcing threads or of cords, including the fine layer of skim compound skim-coating the reinforcing threads or cords if such a layer exists.

One of the tread pattern blocks 51 also comprises a circumferential reinforcing element 8. This circumferential reinforcing element 8 comprises a skin 81 and a core 82. The reader may refer to Table 1 (paragraph 77) of the aforementioned patent application WO2016/174100 in order to learn of a rubber composition cited for the “mono-material” reinforcing element, which is a rubber compound suitable for the skin. The mixture of rubbers that makes up the rubber compound of the skin 81 thus produced has a dynamic shear modulus G* (measured at 60° C. at 10 Hz and under an alternating shear stress of 0.7 MPa) of 30.3 MPa. The reader may refer to Table 2 (paragraph 88) of the aforementioned patent application WO2016/174100 in order to learn of a rubber composition cited for the predominant material used for the tread, which is a rubber compound suitable for the core and, of course, also suitable for the tread. The mixture of rubbers that makes up the rubber compound thus produced has a dynamic shear modulus G* of 0.9 MPa.

Advantageously, all of the blocks 51 are provided with a circumferential reinforcing element 8. The shape of the circumferential reinforcing elements depicted is triangular, but this shape may vary and the lateral walls may be concave, convex or in the form of a staircase, notably without departing from the scope of this invention. In FIG. 1, as in FIG. 1b, the circumferential reinforcing element 8 has an external contour in the shape of a triangle and a core 82 likewise in the shape of a triangle, the axially exterior lateral face of the triangle corresponding to one of the lateral faces of a groove 7. FIG. 1b shows a solution in which the circumferential reinforcing element 8 is laid on a sublayer 10 of a thickness from 1 mm to 2 mm.

The circumferential reinforcing element 8 appears at the contact face of the tread that is intended to come into contact with the roadway while the tyre is being driven on. The circumferential reinforcing element 8 forms one of the lateral faces 72 of a circumferential groove 7; as an alternative, being delimited, the circumferential reinforcing element 8 is able to not be at the edge of a tread pattern block 51, the distance from the circumferential reinforcing element 8 to one of the lateral surfaces 72 then preferably being less than 2 mm.

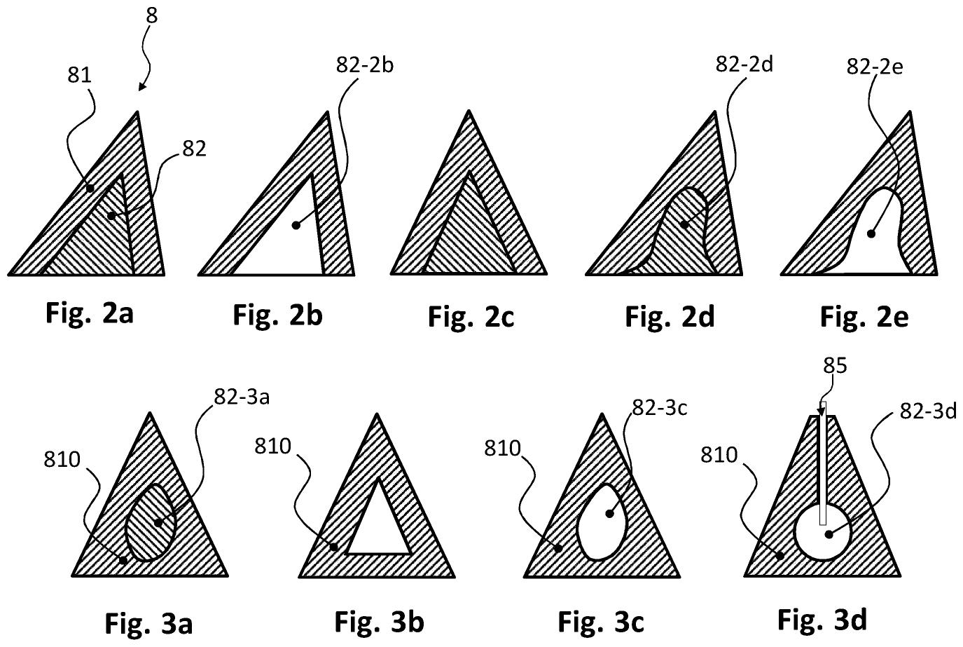

FIGS. 2b to 2c show variations in shape along these lines. FIGS. 2a and 2b show a reinforcing element in the shape of a triangle which is inclined axially, whereas the reinforcing element in FIG. 2c forms an isosceles triangle, i.e. is axially symmetric. In FIG. 2b, the core 82-2b is empty of any material, this being a highly specific form of embodiment of a material that is less stiff than the skin material. In FIGS. 2d and 2e, the core 82-2d, 82-2e is in the shape of a bell, empty of any material in the case of FIG. 2e.

In FIGS. 3a to 3d, the skin material is extended to form a sole 810 at the base of the triangle. In FIGS. 3a and 3c, the meridional cross section of the core 82-3a, 82-3c has an oval shape, the core 82-3c being empty of any material in the alternative form of FIG. 3c. In FIG. 3b, the core has a meridional cross section of triangular shape and is empty of any material; of course, it could be filled with a core material as in the case of FIG. 3a. The core 82-3d is also empty of any material in the case of FIG. 3d, in which the core is approximately circular in shape and is surmounted radially by a slit 85 leading to the vertex of the triangle. On account of its closed structure, the solution of FIG. 3a makes the reinforcing element easier to produce by coextrusion. Again on account of their closed structures, the solutions set out in FIGS. 3b and 3c also make production by extrusion easier, by comparison with the solutions 2b and 2e. Solution 3d has the advantage that it can be moulded using a sipe blade which at its base has a cylindrical form creating a “teardrop”.

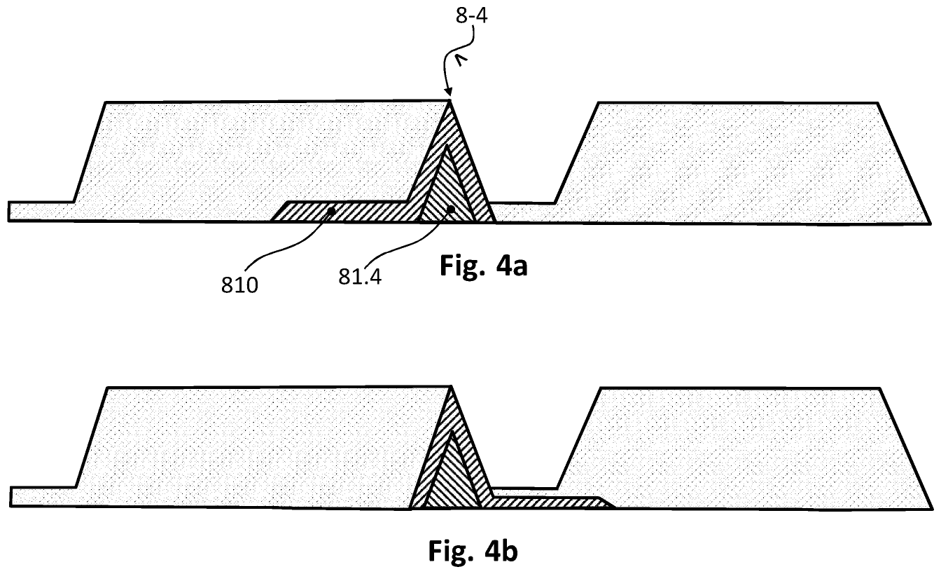

In FIG. 4a, the reinforcing element 8-4 comprises a main part, in the shape of a triangle identical to the example of FIG. 1, the sole 81-4 of the said part being extended axially by a tongue 86 of the same material as the skin compound. The example of FIG. 4b is comparable with that of FIG. 4a, except that it comprises a tongue extending the sole of the said main part axially on the other side. The solutions depicted in FIGS. 4a and 4b offer the advantage of improving the anchorage of the reinforcing element to the crown reinforcement.

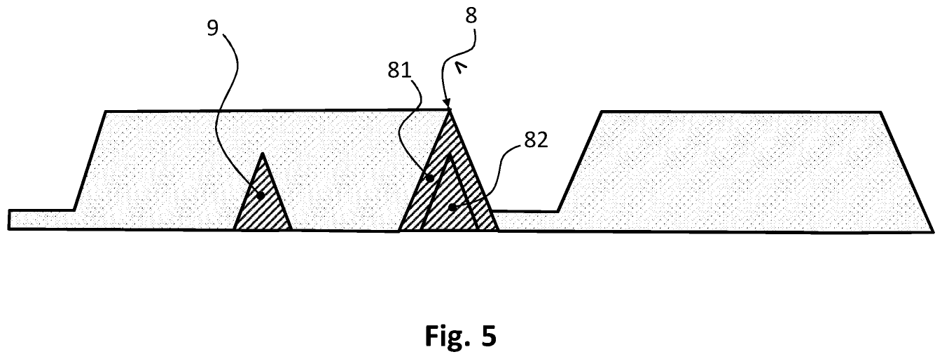

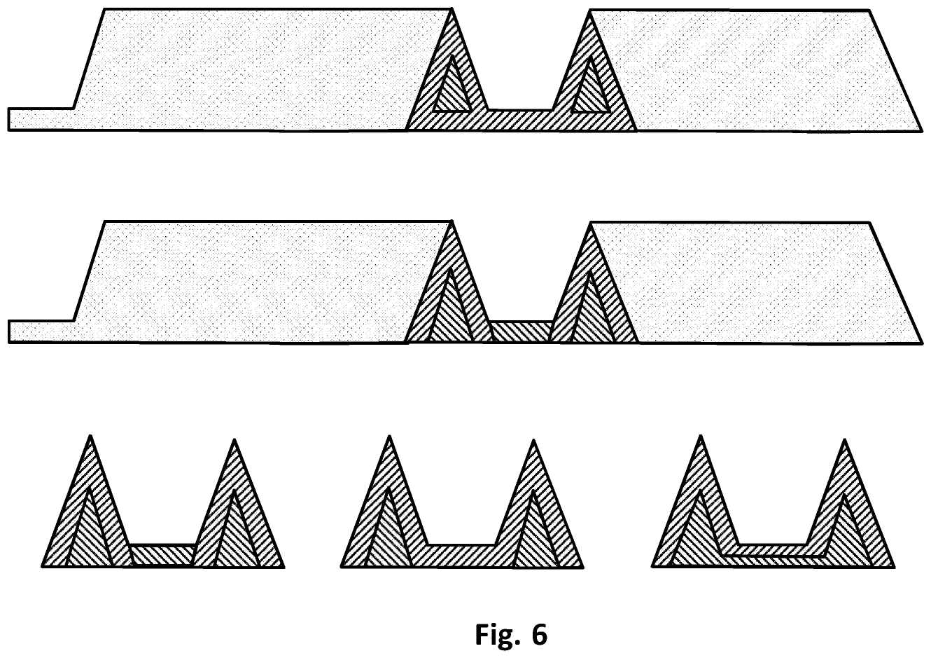

Note too that it is possible to use a reinforcing element according to the present invention with other types of reinforcing elements such as, for example, a reinforcing element according to any one of the teachings of the aforementioned documents. FIG. 5 illustrates the combined use of a reinforcing element 8 comprising a skin 81 and a core 82 according to the present invention, and a reinforcing element 9 made of one single material, as is found in document WO2016/174100. This application allows for a better distribution of stress through the block 51, making the reinforcement more effective, particularly in the case of high transverse stress loadings.

In instances where reinforcing elements on each side of a longitudinal groove are planned, precise forms of embodiment are exemplified in FIG. 6.

These variations in the shape of the meridional cross section can be used for any position of the reinforcing element within the tread. The illustrated variations in the shape of the reinforcing element are nonlimiting.

1.-10. (canceled)

11. A tire comprising a crown reinforcement and a tread radially on the outside of the crown reinforcement,
the tread having a contact face intended to come into contact with the roadway when the tire is running, and the tread comprising at least one circumferential reinforcing element of which at least part of the meridional cross-section has a shape of a triangle, the vertex of which is oriented radially toward the outside,
wherein the circumferential reinforcing element comprises a skin and a core, the skin being at least twice as stiff as the core.

12. The tire according to claim 11, wherein the skin and the core are each made of a rubber compound, a dynamic shear modulus G*, measured at 60° C. at 10 Hz and under an alternating shear stress of 0.7 MPa, of the rubber compound of the skin being at least twice as high as a dynamic shear modulus G*, measured at 60° C. at 10 Hz and under an alternating shear stress of 0.7 MPa, of the rubber compound of the core.

13. The tire according to claim 12, wherein a remainder of the tread, other than the at least one circumferential reinforcing element, is made from a rubber compound, a dynamic shear modulus G* of the rubber compound of the skin being at least twice as high as a dynamic shear modulus G* of the rubber compound of the remainder of the tread.

14. The tire according to claim 12, wherein the rubber compound of the skin has a dynamic shear modulus G* greater than 5 MPa.

15. The tire according to claim 11, wherein the tread comprises a plurality of tread pattern blocks, two tread pattern blocks being axially separated by a groove, each of the grooves extending at least partially circumferentially, each of the grooves being axially delimited by two lateral faces and delimited radially toward the inside by a groove bottom, and
wherein at least some of the tread pattern blocks comprise at least one circumferential reinforcing element.

16. The tire according to claim 15, wherein the at least one circumferential reinforcing element forms one of the lateral faces of a circumferential groove.

17. The tire according to claim 11, wherein a remainder of the tread, other than the at least one circumferential reinforcing element, has a dynamic shear modulus G*, measured at 60° C. at 10 Hz and under an alternating shear stress of 0.7 MPa, of less than or equal to 1.3 MPa.

18. The tire according to claim 11, wherein the core is empty of any material.

19. The tire according to claim 18, further comprising an additional reinforcing element made of a single material.

20. The tire according to claim 11, wherein the at least one circumferential reinforcing element appears at the contact face of the tread that is intended to come into contact with the roadway while the tire is running.
